(19) United States
(12) Patent Application Publication
(10) Pub. No.: US 2013/0333544 A1
(43) Pub. Date: Dec. 19, 2013

(54) Novel Karaoke and Multi-Channel Data Recording / Transmission Techniques via Wavefront Multiplexing and Demultiplexing

(71) Applicants: Steve K Chen, Pacific Palisades, CA (US); Donald C.D. Chang, Camarillo, CA (US)

(72) Inventors: Donald C.D. Chang, Thousand Oaks, CA (US); Steve K Chen, Pacific Palisades, CA (US)

(21) Appl. No.: 13/938,268

(22) Filed: Jul. 10, 2013

Related U.S. Application Data
(63) Continuation of application No. 12/848,953, filed on Aug. 2, 2010.
(60) Provisional application No. 61/338,138, filed on Feb. 16, 2010.

(51) Int. Cl. G10H 1/36

(52) U.S. Cl. CPC G10H 1/361
USPC 84/610; 700/94

(57) ABSTRACT

A concurrent multi-channel data process is presented to utilize wavefront multiplexing for data storage and data stream transport in a distribution network, with additional applications for multi-media recording and data communications via transponding satellites. Multiple concurrent data streams are pre-processed by a wavefront multiplexer into multiple sub-channels or wavefront components, where signals from respective data streams are replicated into sub-channels. These replicated data streams are linked via a unique phase weighting vector, or “wave-front”, which are also linked by various spatially orthogonal wavefronts. Additionally, probing signals are embedded and linked via some of the orthogonal wavefronts. Aggregated signals in sub-channels are unique linear combinations of all input data streams. Post-processing via a wavefront de-multiplexer converts various sub-channel signals back to the original data streams, utilizing the embedded probing signals to restore orthogonality among multiple wavefronts.

This application is a continuation of application Ser. No. 12/848,953, filed on Aug. 2, 2010, now pending, which claims the benefit of provisional application No. 61/338,138 filed Feb. 16, 2010.

### RELATED APPLICATION DATA

This application claims the benefit, pursuant to 35 U.S.C. §119(e), of U.S. provisional application Ser. No. 61/338,138 filed on Feb. 16, 2010.

U.S. provisional application Ser. No. 61/002,807 filed Nov. 14, 2007 features Wavefront (WF) multiplexing (muxing)/de-multiplexing (demuxing) techniques for coherent power combining of directly broadcast signals from various satellite transponders.

WF muxing/demuxing techniques have been used in a U.S. patent application Ser. No. 12/462,145, filed on Jul. 30, 2009.

### BACKGROUND OF THE INVENTION

1. Field of the Invention

The present invention relates to architectures and designs of multi-channel or multiple-track data recording, transmissions, and/or retrieving systems related to Karaoke, multimedia, or any multiple-channel applications using wavefront (WF) multiplexing (muxing)/demultiplexing (demuxing).

2. Description of Related Art

It is well known that the art of Karaoke utilizes multi-track simultaneous recording. A Karaoke features the original artist singing, along with video and stereo music. A “Karaoke” machine usually features multiple concurrent channel delivery capability for data/information. The data/information is stored in physical memory and fall into three categories; (1) accompanying stereo music, (2) artist vocal tracks, (3) background videos and (4) lyrics. In practice sessions, a player of the Karaoke may just listen to the recorded artist singing initially, and then sing along with the artist recording subsequently. The multimedia features will be displayed by the Karaoke machine on some sort of screening device, usually a television or a projector. The accompanying music and recorded artist vocal will be played accordingly while the associated background videos are displayed on a TV screen. The lyrics to the song are scrolled and illuminated phrase by phrase at the bottom of the screen to remind the player what to sing at any given point during the song. To facilitate the player's experience, all of the data tracks are fully customizable to suit the player's needs, such as adjustable pitch, tone, and tempo. If in need of performing a song, the player can remove the original recording artist's voice, or, if the player is lip-syncing, add the voice back to the track. Additionally, some Karaoke machines add another data track in the form of depicting the player on-screen as a character performing at a venue.

In one such a format, artist vocal recordings usually are mixed with one of the stereo music channels, which are normally recorded in the forms of two separated tracks of R and (L+vocal). The “R” and “L” stands for respectively “right” and “left” channels. When a participant in a bar or in a friendly party decides to sing a favorite popular song in front of a crowd of friends and strangers, he will play the karaoke machine and switch on a “Karaoke” mode via a machine controlling device. The recorded videos and music will then appear on a large TV screen along with accompanying music stereos with the exception of the vocal track. It is the karaoke player who becomes the instant focus of attention. His and/or her voices come out with the accompanied video and music. They risk their image to others by playfully defiling some of the most popular tunes known to man.

Because no two people experience Karaoke in the same way, there are needs to independently “control” the vocal channels for Karaoke machines. For example, the capability of illuminating vocal information during a Karaoke session is achieved via an independent recording of the vocal data/information on separate recording tracks. Because of this, vocal tracks of songs may be recoded in different languages or dialects to be replayed with the original song's accompanying music and videos. Some people might want to sing along with the original recording artist, while others might prefer a cappella style performances. Yet others might prefer singing in different pitches or tempo from the original song. Thus, the ability to change the data tracks on a Karaoke machine is necessary to facilitate a good user experience.

Other examples of multi-channel delivery systems are video games, Cable TV, Direct Broadcast Satellite (DBS). They all feature multiple data and/or information streams either recorded concurrently, or delivered simultaneously.

In video games, a group of players may play against each other within a given game space, sharing much of the same multimedia information while at the same time interacting with one another remotely based on customized real time information of individual players involved in a game. For example, the popular massive multiplayer online role-playing game World of Warcraft may feature tens of thousands of players within the same persistent game space. Due to the real-time nature of the game, fresh data must be continually transmitted and received between the game servers and the users' client computers. As a result, a unique set of data must be sent to each of the thousands of users, which means massive bandwidth usage. However, a simpler way to identify individual players is via different channels. All the information can be grouped into multiple channels. Multiple channel data can flow among the players or between players and their associated hubs.

TV broadcasting in today's cable delivery systems occupies a portion of cable bandwidth while other services such as two way internet and telephone services utilize other portions of the bandwidth. Cable TV headers aggregate many TV programs concurrently into different frequency slots. Since each frequency slot is allotted a different TV channel, there are hundreds of channels aggregated together within the same bandwidth. Multiple TV programs are aggregated concurrently and delivered (broadcasted) to all customers simultaneously via a cable distribution network.

In a DBS delivery system, multiple TV channels may be statistically multiplexed together in a time domain to form a single signal stream for an individual transponder for maximizing satellite power radiation efficiency. In addition, different sets of multiple TV programs are delivered by various transponders. A DBS delivery platform may require multiple satellites at different orbital slots re-using the same frequency spectrum many times. Multiple TV programs are aggregated concurrently and delivered (broadcasted) to all customers simultaneously via a DBS delivery platform.

### SUMMARY OF THE INVENTION

The present invention is to record multimedia data via multiple tracks, but every track will feature a mixture of all the data: video, accompanying stereo music, and (multiple) vocals. Furthermore, every set of data will appear in all the tracks independent of whether the data set is for video, accompanying music, or artist vocals. Therefore an individual track will have a record featuring all the data but with a fixed “mixture.” It may even be possible to design the mixture so that a recorded track can be played on “regular” record players to deliver videos, accompanying stereo music, and an artist vocal. However, the artist vocal can not be separated from the accompanying stereo music. They are mixed with a certain mixtures with one another by the “mixtures” formatted in the recording process.

On the other hand, the mixing methods among individual recorded tracks are related but different, so that when multiple tracks are played simultaneously, vocal data become independently retrievable through a post-processing. Therefore, it becomes possible to independently enhance or illuminate the artist vocal without altering the quality of the accompanying music.

The proposed technique is to enhance the security and integrity of recorded data, and is not for the sake of saving bandwidth.

The techniques being presented will involve data and signal processing both on the recording side and data retrieving side. Let us refer to the processing on the recording side as pre-processing, and those at the retrieving side as post-processing. Since there is a significant bandwidth difference between the audio and video data streams, it is more bandwidth efficient in processing that only audio channels are processed and video channels are bypassed in the wavefront multiplexing. However, to circumvent this issue, it is possible to subdivide a video channel into multiple sub-bands, resulting with the video sub-bands and audio channels becoming comparable in bandwidth. However, we will use multiple audio channels (or tracks) as examples to illustrate the concepts. The same concepts can be applied for multiple videos tracks, and or multiple multi-media tracks, such as means of delivering cable TV or Direct-to-Home broadcasting. The techniques for the recording industry in general can be extended to other applications. It may used to transport multiple track data from one place to others. It can be used for digital data storage.

We assume there are M channels audio inputs; some are accompanied grouped audios (music), and others are vocal tracks. M may range from 2 to 10 and will not exceed 20 normally. The M inputs are processed by three separate functions in series. The first one is the wavefront (WF) multiplexing (muxing) processing, which transforms N input streams into N output streams. We use M of the N inputs for signals, and the remaining N-M inputs for diagnostics, data integrity verifications, and authentications. In general, N is no less than M.

The second processing is a multiple channel security locking mechanism with N-inputs and N-outputs, which may simply be concurrent modulations by a fixed or dynamic complex “weighting” vector, which is an N component multipliers on the N data streams. Each complex component consists of both in-phase (I) and quadrature-phase (Q) portions; or equivalently an amplitude (A) and a phase (φ) portions. An additional mechanism is through an N-to-N channel switching processing; which is achievable via a set of fixed rules or a lookup table (LUT) for I/O routing.

For instance, there are 8 slots of the input (I) channels and 8 slots of output (O) channels. The 8 “I” channels are arranged in sequence from the top to the bottom as (I1, I2, I3, I4, I5, I6, I7, I8). Similarly there are 8 output channels, and they are arranged in sequence from the top to the bottom as (O1, O2, O3, O4, O5, O6, O7, O8). Furthermore, I1 port is connected to O7 port. In addition, I3 and O5, I5 and O3, as well as I7 and O1 ports are inter-connected, respectively. Therefore the 8 channel input data streams labeled as [1, 2, 3, 4, 5, 6, 7, 8] from the top to the bottom may be altered in a locking mechanism to the following output sequence from the top to the bottom as [7, 2, 5, 4, 3, 6, 1, 8].

The N-channel locking mechanisms may also be many other possibilities of combining both techniques of the weighting and LUT mechanisms.

The third processing converts the N outputs of the locking mechanisms into a single data streams with N times higher speed.

The single stream of data is recorded on portable storage hardware, local memory, or sent in real time to remote users/storages via Internet or other wired or wireless means.

For post-processing, the sequence of the three functions is reversed. First, the single stream of data recorded or sent is converted to N parallel streams via a time-domain de-multiplexing processing. The total data flow rates are identical; therefore the input single stream will feature N times faster than that of the N concurrent output data streams. This is also an optional block. When recorded data were multi-channel concurrent recording, this block would be bypassed in the data retrieving process.

In the second function processing, the N input streams are sent to an electronic “key” process to do the decryptions, reversing the locking mechanisms through combinations of routing via a LUT, and “weighting” process, recovering the N sub-channel signals; or N streams of muxed components of the audio signals in our example. This is also optional.

The third processing is the WF demuxing (de-multiplexing) which converts the N sub-channel components to M multi-channel audio signal components and N-M components for diagnostics, integrity verification, and authentications.

### BRIEF DESCRIPTION OF THE DRAWINGS

FIG. 1 depicts the functional block diagram of proposed recording and playing schemes for multiple channels signals.

FIG. 2 depicts the functional block diagram of proposed real time delivery schemes for multiple channels signals.

FIG. 3 depicts the functional block diagram of proposed data storage and retrieving schemes for multiple channels signals.

FIG. 4 depicts a block diagram of a wave front multiplexing scheme for multiple channels signals processing in accordance with the present invention;

FIG. 5 is a block diagram of an example of a multi-channels electronic locking mechanism in accordance with the present invention; and

FIG. 6 illustrates an example of a time domain multiplexing processor converting multi-channels in parallel to a single data stream with higher rate in recording, storage and/or real time transmission in accordance with the present invention.

FIG. 7 illustrates an example of a time domain de-multiplexer converting a single stream of data into multiple parallel channels signal streams in retrieving data and/or real time receptions in accordance with the present invention.

FIG. 8 is a block diagram of an example of a multi-channels electronic un-locking mechanism in accordance with the present invention; and

FIG. 9 depicts a block diagram of a wave front de-multiplexing scheme for multiple channels signals processing in accordance with the present invention;

FIG. 10 depicts a block diagram of an advanced Karaoke system utilizing wave front de-multiplexing scheme in accordance with the present invention;

FIG. 11 depicts a block diagram of a multi-channel secured satellite communications system utilizing multiple transponders concurrently via WF muxing/demuxing techniques in accordance with the present invention;

### DETAILED DESCRIPTION OF THE PREFERRED EMBODIMENT

The present invention provides advanced channel signal storage, delivery, and retrieving systems that are capable of providing data security, detecting data contaminations, and authenticating received data. In the detailed description that follows, like element numerals are used to indicate like elements appearing in one or more of the figures.

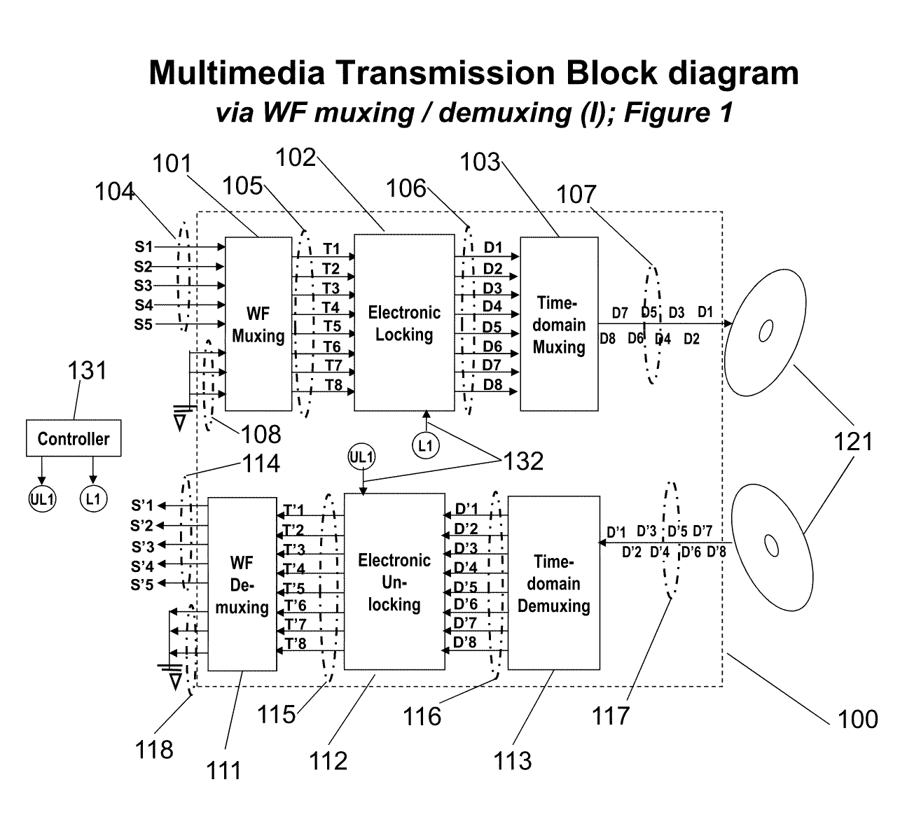

FIG. 1 illustrates a block diagram for (1) recording multi-channels data streams on a portable storage device via WF muxing process, (2) retrieving the recorded data from the portable device via WF de-muxing processing, and (3) portable storage devices. The recorded data are encrypted and converted to a single track for recording. We will use audio recording of multiple songs as an example. The same techniques are applicable to recording multi channel video data or multi-media data in general.

The data storage and retrieving system (100) consists of data recording and data retrieving functions. In the data recording, there are three function blocks; the WF muxing (101), the electronic locking (102), and time-domain muxing (103) which perform input/output (I/O) format conversion from N parallel data streams to a single serial data stream.

WF muxing (101) is a functional operation mathematically. As a result, every output is a linear combination of all the inputs, and every input is in all the outputs. There are many mathematical functions which are applicable for WF muxing and demuxing. In this embodiment, a 1-D 8-to-8 fast Fourier transform algorithm (FFT) in spatial domain is chosen in our example, or N=8 as depicted in FIG. 1. Both inputs (104, 108) and outputs (105) are sequenced, from top to bottom, as 1 to 8. We shall refer the inputs (104, 108) as sub-band or WF ports and signals flowing through them the subband or WF signals. Five of the 8 inputs are connected to 5 audio (or multimedia) signal streams respectively. The present embodiment's five audio inputs (104) are [S1, S2, S3, S4, S5]. There are three un-used input ports (108) which are grounded as indicated. However, the un-used inputs (108) may not be grounded by unique referencing signal patterns either fixed or dynamic diagnostic and authentications. Grounding the unused input ports (108) simply sets the referencing signal patterns to “zero” continuously.

The 8 outputs (105), [T1, T2, T3, T4, T5, T6, T7, T8], are referred as subchannel ports. The signals streams flowing through them are the sub-channel signals streams.

Mathematically the 8-to-8 WF-muxing process (101) generates 8 outputs (105), Tn(t), from the 8 inputs (104, 108), including the three grounded signals (108). The 8 outputs (105) are the 8 subchannel signal streams, Tn(t), are related to the sub-band signals streams, Sx(t) as:

Tn(t)=ΣSx(t)*exp(−j2πnx/8), (1)

where the Σ operated over all x; from 1 to 8, but

S6(t)=S7(t)=S8(t)=0, and

n varying brom 1 to 8

Let us make an observation on distribution among the Tn(t) for a signal stream going through a WF port, say S3(t). The S3(t) signal stream is replicated, weighted individually, and placed on all the 8 subchannels. The weighting is a “multiplication” process mathematically in which the multiplicant is the signal stream and the multiplier is a complex weight, which can either be represented in I-and-Q or be written in amplitude-and-phase.

The replicated signal streams are weighted by exp(−j 6π n/8) respectively for various n. The replicated signal streams of S3(t) in [T1(t), T2(t), T3(t), . . . , T8(t)] are weighted by a weighting vector W3, where

W3=[exp(−j3π/4),exp(−j6π/4),exp(−j9π/4), . . . , exp(−j24π/4)] (2)

It is clear that there is a unique feature of a phase progression among the replicated S3(t) signal steams concurrently flowing through the 8 subchannels (105). There is a constant phase difference of (−j3π/4) radiants between the replicated S3(t) signal steams in any two (contiguously) adjacent subchannels.

Similarly signal stream flowing through the 7^{th} WF port, the S7(t), will also be replicated and weighted by W7, and then placed on 8 subchannels (105) accordingly, where

W7=[exp(−j7π/4),exp(−j14π/4),exp(−j21π/4), . . . , exp(−j56π/4)] (2).

W7 also features a linear phase slope but with a different phase progression among the 8 replicated S7(t) signal steams flowing through the subchannels (105). The linear phase slope of W7 equals to (−j7π/4) radiants per subchannel increment.

These phase progressions distributed among the subchannels are called the “wavefronts.” We make the following observations: (1) W3×W3*=W7×W7*=8, and (2) W3×W7*=W7×W3*=0. The two WFs (wavefronts) are orthogonal to each other.

The WF muxing processing enables the following:
a. A signal stream from one of the WF ports (104, 108) flowing through all subchannels (105) concurrently with a unique wavefront.
b. There are 8 unique WFs associated to 8 WF ports:
   i. Signals streams from various WF ports features different phase slopes among the subchannels.
   ii. These WFs are orthogonal to one another.
c. A signals stream flowing through one of subchannels (105) consisting of signals streams in all WF ports (104, 108) concurrently
   i. there are no requirements in one of the subchannels (105) on “coherency” among various replicated WF signal streams, e.g. S3(t) and S7(t), at all.
d. A signal streams in anyone of the subchannels (105) shall exhibit a feature of pseudo random noises due to mutual interferences among all 8 signals from the WF ports (104, 108).

Since the grounding of unused ports (108), the five input audio tracks are converted into 8 sub-channels (105); each features a unique linear combination of the five input signals (104).

The optional second block (102) in the recording chain features are 8 inputs (105) and 8 outputs (106), performing multi-channel encryptions. This block is optional, and may be bypassed in implementation so that the data streams will not be encrypted.

It (102) consists of two cascaded processing. The first processing is a vector operation of complex “weighting” for all input channels (105) by a weighting vector. There are 8 inputs, Tm(t) (105); and 8 outputs, Lm(t) (404). The second processing is I/O switching via a look-up table (LUT). There are 8 inputs, Lm(t) (404) and 8 outputs Dm (106).

As to the weighting mechanisms, the outputs, Lm(t),

Lm(t)=Wlm*Tm(t), (3)

where Wlm are the lock-weighting constants, m=1 to 8,

In the I/O switching processing, there are 8 input (I) ports (404) and 8 output (O) ports (106). The 8 “I” channels are arranged in sequence from the top to the bottom as (L1, L2, L3, L4, L5, L6, L7, L8). Similarly the 8 output channels (106) are arranged also in sequence from the top to the bottom as (D1, D2, D3, D4, D5, D6, D7, D8). Furthermore in a LUT, L1 port is set to be connected to D7 port. In addition, L3 and D5, L5 and D3, as well as L7 and D1 ports are also set to be inter-connected, respectively. Therefore the 8 data streams flowing through the 8 input ports Lm (404), and are labeled, from the top to the bottom, as

[1st,2nd,3rd,4th,5th,6th,7th,8th] (4)

The sequence of the 8 data streams at the 8 outputs (106) from the top to the bottom becomes the following sequence

[7th,2nd,5th,4th,3rd,6th,1st,8th] (5).

Both the weighting and I/O switching processing are programmable. When the weighting vector is set to unity for all input elements (105), the resulting locking mechanism (102) becomes a I/O switching only.

On the other hand, when I/O switching is set to have all O-ports of a LUT set to the I-ports accordingly, the resulting locking mechanisms (102) will feature only the “weighting” mechanisms. When the weighting vector equal unity and all O-ports set to I-ports, the locking mechanisms (102) provide a by-pass function. There is no locking mechanisms imposted on to the recorded multichannel data.

Contaminations of “weighting” on recorded multichannel data (106) may happen “naturally” due to unbalanced recording channels, “aging” of electronics, or propagation effects when recorded remotely. On the other hand, phenomena on recorded multimedia from I/O switching will not occur naturally. Therefore the phenomena of “weighting” due to unbalanced recording channels, “aging” of electronics, or propagation effects can be calibrated out in operation by design, to allow the “weighting” portion of the locking mechanisms functioning properly.

The time domain muxing processing (103) is also optional, and it converts the 8 concurrent inputs (106), Dm(t), into a single data stream (107) with 8 times higher speed.

The single stream of data (107) are recorded on portable storage hardware (121). Without the time domain muxing (103), the recording format will be 8 parallel concurrent channel signals.

There are additional controller (131) functions which are simplified providing an electronic locking file with data on locking codes and associated un-locking keys through controlling buses (132).

In the data retrieving chain, there are three function blocks; the WF de-muxing (111), the optional electronic key (112), and an optional time-domain demuxing (113) which perform input/output (I/O) format conversion from a single serial data stream to N parallel data streams.

A single stream of data (117) are retrieved from a portable storage device (121).

The time domain demuxing processing (113) converts a single data streams (117) into 8 concurrent outputs (116), D′m(t). The 8 output data streams are flowing with ⅛ times data speed as that of a the single input data stream.

The second block (112) in the data retrieving chain performs the electronic-un-locking process, featuring 8 inputs (116) and 8 outputs (115), performing multi-channel decryptions. It performs the reversed processing of those in the locking mechanism (102), and consists of two cascaded processing.

The front processing is a I/O switching mechanism via a look-up table (LUT). It performs the reversing to un-do the channel switching. There are 8 inputs, D′m(t) (116) and 8 outputs L′m (504).

The second processing in the unlocking mechanism is a vector operation of complex “weighting” for all 8 input channels L′m(t) (504) by a weighting vector. There are 8 outputs, T′m(t) (115). As to the weighting mechanisms, the outputs, T′m(t),

T′m(t)=Wulm*L′m(t), (6)

where Wulm are the unlock weighting constants, m=1 to 8,

WF demuxing (111) is also a functional operation mathematically. As a result, every output is a linear combination of all the inputs, and every input is in all the outputs. A 1-D 8-to-8 IFFT in spatial domain is chosen in our example. Both inputs (115) and outputs (114, 118) are sequenced, from top to bottom, as 1 to 8. We shall refer the inputs (115) as sub-channels ports and signals flowing through them the sub-channel signals.

The 8-to-8 WF-demuxing process (111) generates 8 outputs (114, 118), S′n(t), from the 8 subchannel inputs (115), [T′1(t), T′2(t), T′3(t), T′4(t), T′5(t), T′6(t), T′7(t), T′8(t)]. The 8 outputs (114, 118), S′n(t), are related to the 8 subband signals streams (115), T′m(t) as:

S′n(t)=ΣT′m(t)*exp(j2πnm/8), (7)

where the Σ operated over all m; from 1 to 8, and n from 1 to 8.

Five of the 8 outputs (114, 118) are connected to 5 audio signal streams respectively. The five audio outputs (114) are [S′1, S′2, S′3, S′4, S′S]. Furthermore, it can be shown that

S′n(t)=Sn(t),where n=1 to 8, (8)

for all the n′s, if and only if the retrieved multiple sub-channel data are identical to the original ones; i.e.

T′m(t)=Tm(t),where m=1 to 8 (9)

The remaining three output ports (118) which correspond to the grounded port in the WF muxing processing (101) shall feature no signal at all. These ports (118) can be used to evaluate the quality of recorded data, to diagnostic whether the player electronics are equalized for restoring the multiple csub-channel data, and/or to detect contaminations on recorded data.

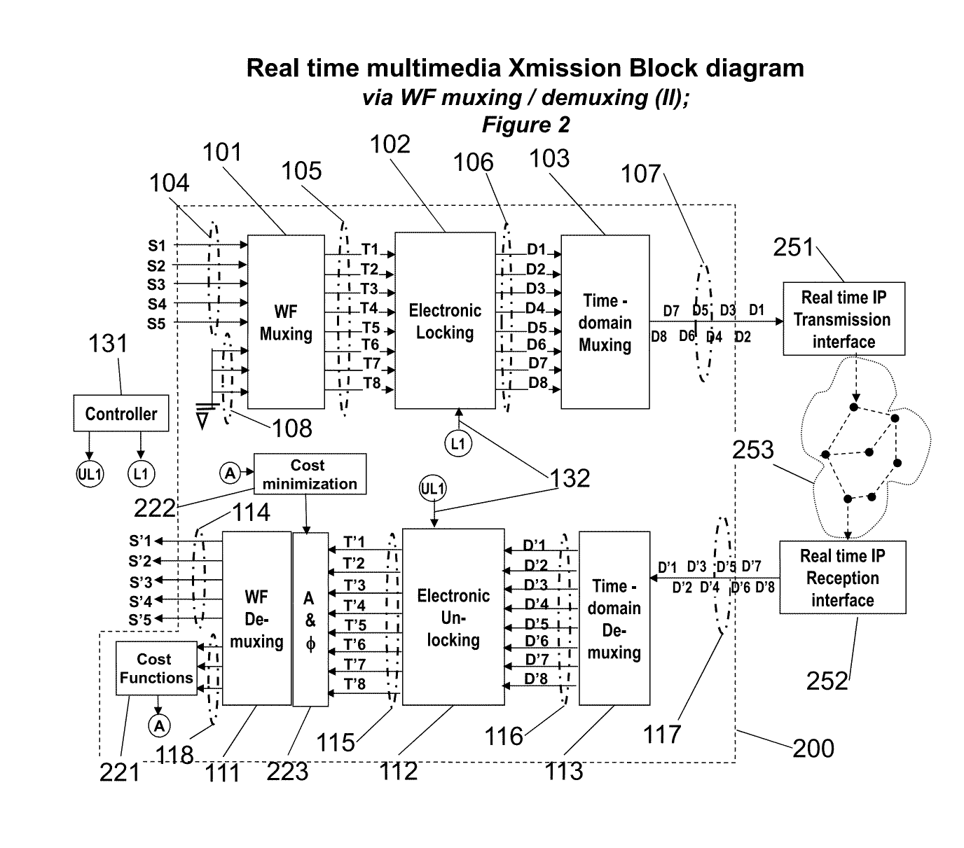

FIG. 2 depicts a block diagram for real time multi-channels data transmission and receptions via WF muxing/demuxing. It is generated by modifying FIG. 1. More specifically, the following are the modifications:
1. The portable recording devices (121) are eliminated,
2. A “real time transmission interface” (251), a “real time reception interface” (252), and a propagation and distribution network (253) are added. The network may be wired or wireless
3. A cost measurement box (221) is inserted, and its inputs are connected to the 3 output ports (118) of the WF demuxing processor
4. A optimization calculation box (222) is inserted, its inputs are provided by the cost measurement box (221) and its outputs are used by the sub-channel weight updating box (223)
5. A sub-channel weight updating box (223) is inserted just before the WF demuxing processing (115), and after the 8 sub-channel inputs (115).

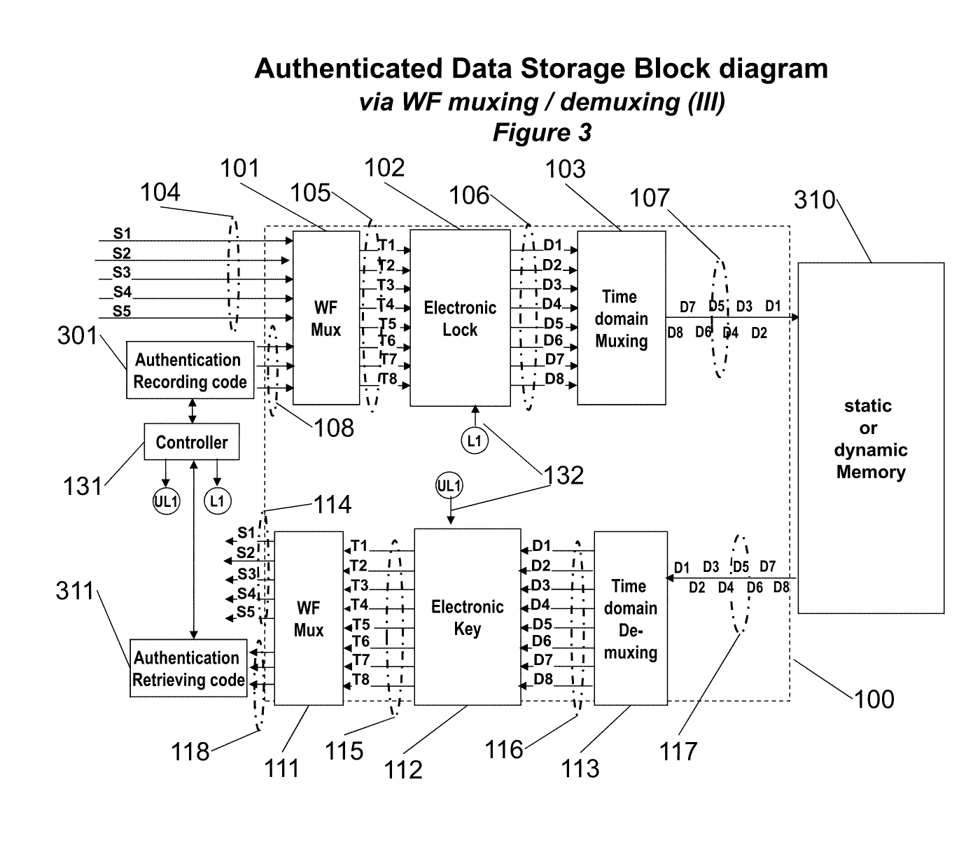

FIG. 3 depicts a block diagram for authenticated data storage via WF muxing/demuxing principle. It is base on concurrent multiple data steams. The data is preprocessed before storage. As a result, the stored data is in multiple memories, and each memory records a linear combination of multiple data sets. Multiple sets of memories store various linear combinations of the same set of data. During the retrieving process, data are re-constituted by a post processing of linear combinations of recorded data sets. The preprocessing and post processing are based on WF muxing and demuxing, which can provide a means for diagnostic information on quality of stored data, and authentications on the contents of stored data. Additional processing is added to encrypt and decrypt sub-channel signals.

FIG. 3 is generated by modifying FIG. 1. More specifically, the following are the modifications;
1. The portable recording devices (121) are eliminated,
2. A block of “static or dynamic memory” (310) is added,
3. A cost measurement box (221) is inserted, and its inputs are connected to the 3 output ports (118) of the WF demuxing processor,
4. A optimization calculation box (222) is inserted, its inputs are provided by the cost measurement box (221) and its outputs are used by the sub-channel weight updating box (223),
5. A sub-channel weight updating box (223) is inserted just before the WF demuxing processing (115), and after the 8 sub-channel inputs (115),
6. A block of “authentication recording code” (301) is added. The recording codes may be a pattern of multi-channel data; an image or stream of numbers representing local recording time. This block is connected to a controller (113),
7. A block of “authentication retrieving code” (311) is added. This block is connected to a controller (113). The retrieved code will be sent to controller for comparison with the recorded authentication codes.

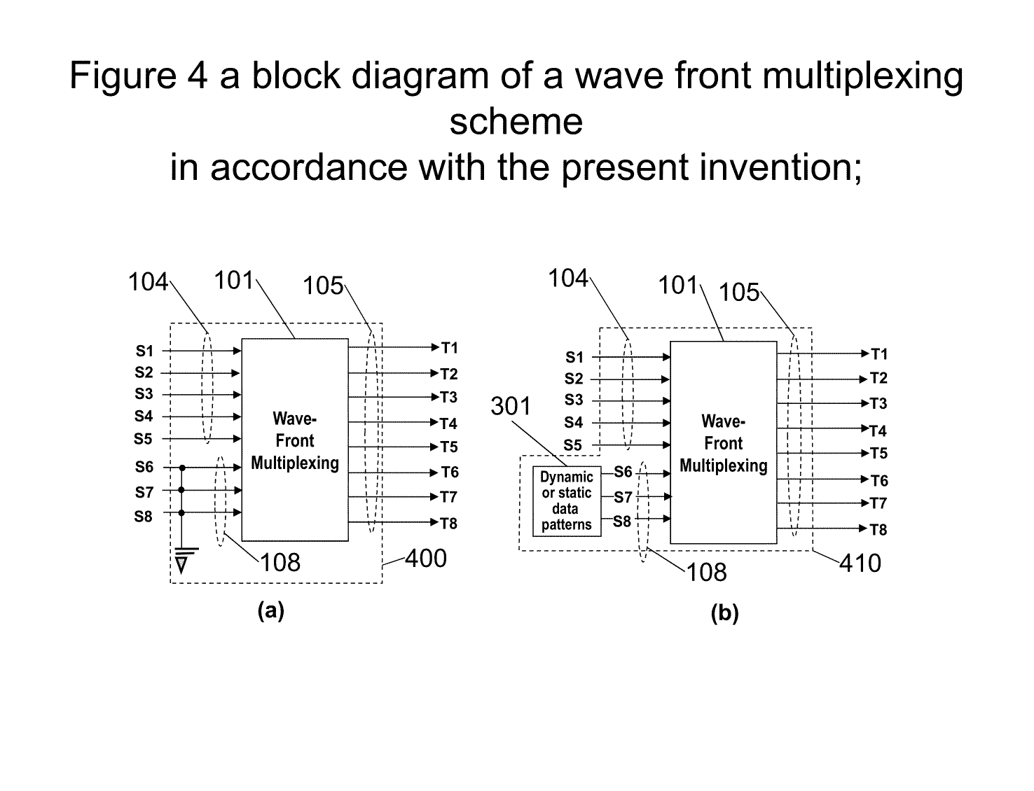

FIG. 4 illustrates 2 WF muxing operation configurations (400, 410). In both configurations, a WF muxing process features 8 inputs (104 and 108), Sx(t) and x=1 to 8, and 8 outputs (106), Tn(t) and n=1 to 8. As depicted in equation (1)

$$\begin{matrix}Tn ( t ) = \sum Sx ( t ) * exp ( - j2π nx / 8 ) , & ( 1 ) \\ = \sum W nx * Sx ( t ) & ( 1 a )\end{matrix}$$

where Σ operation is over all x and x=1 to 8, and n=1 to 8;

Wnx is the complex weight component.

$$Therefore , \begin{matrix}Wnx = exp ( - j2π nx / 8 ) \\ = cos ( 2 π nx / 8 ) - jsin ( 2 π nx / 8 )\end{matrix} \qquad ( 1 b )$$

Its conjugate can be written as:

$$\begin{matrix}{Wnx}^{*} = exp ( j2π nx / 8 ) \\ = cos ( 2 π nx / 8 ) + jsin ( 2 π nx / 8 )\end{matrix} \qquad ( 1 c )$$

Let us define a weighting vector Wn and its conjugate Wn* as follows;

Wn=[Wn1,Wn2,Wn3,Wn4,Wn5,Wn6,Wn7,Wn8] (1d)

Wn*=[Wn1*,Wn2*,Wn3*,Wn4*,Wn5*,Wn6*,Wn7*,Wn8*] (1e)

For examples, n=3 and 4, the weighting vector W3 and W4 can be written as

W3=[W31,W32,W33,W34,W35,W36,W37,W38]

W4=[W41,W42,W43,W44,W45,W46,W47,W48]

These weighting vectors are the WFs. They feature unique characteristics:

Wn×Wm*=0,if n≠m,and (11a)

Wn×Wn*=N,(N=8 in our example)for n=1 to N. (11b)

Any transformations which meet the two conditions, (11a) and (11b), can be used for WF muxing operations.

In FIG. 4, there are two WF muxing architectures, which are identical to those WF muxing processing (101) in FIGS. 1, 2, and 3. A WF muxing process features 8 inputs (104 and 108), Sx(t) and x=1 to 8, and 8 outputs (106), Tn(t) and n=1 to 8. Every input port corresponds to a unique WF.

Five inputs (104) are for multiple channel data, and the remaining three inputs (108) are for diagnostics and authentications. These diagnostic and/or authentication signals are “mixed” with the desired multi-channel data streams embedded in all sub-channel signal streams. At destinations they will be reconstituted via WF demuxing processing. The recovered signals will be compared with stored references for diagnostic and/or authentication purposes.

FIG. 4a is the architecture that the diagnostic and authentication inputs (108) are grounded. There are no signals for the diagnostic and authentication inputs. We use the grounding as the signals for diagnostics. When preprocessing and post-processing are perfectly equalized, the reconstituted signals at the diagnostic and/or authentication ports at a destination shall be “no signal” at all only when with no contaminations or corruptions on transporting or recording the desired multi-channel data. When and if signals appear at the diagnostic and/or authentication ports at a destination, there are two possible causes
1. preprocessing and corresponding post processing are not calibrated and equalized, or
2. the recorded data may have been contaminated and shall not be the desired ones.

FIG. 4b is the architecture that the diagnostic and authentication inputs (108) are not grounded but injected with specially designed data patterns by a data pattern generator (301). These patterns may be static or dynamic. When preprocessing (410) and post-processing (710) are perfectly equalized, the reconstituted signals at the diagnostic and/or authentication ports at a destination shall be the specially designed data patterns only when with no contaminations or corruptions during transporting or recording the desired multi-channel data. When and if different data patterns appear at the diagnostic and/or authentication ports at a destination, the recorded data may have been contaminated and shall not be the desired ones.

Both architectures in FIGS. 4a and 4b do not require scrutinizing the desired multi-channel data at all, while providing a reliable means to make judgments on the “quality” of recorded and/or transported data.

By various specially designed patterns, these ports (108) can be used for both diagnostic and authentications. Pre-processing and post-processing can be equalized and calibrated to take out electronic aging and time varying propagation effects.

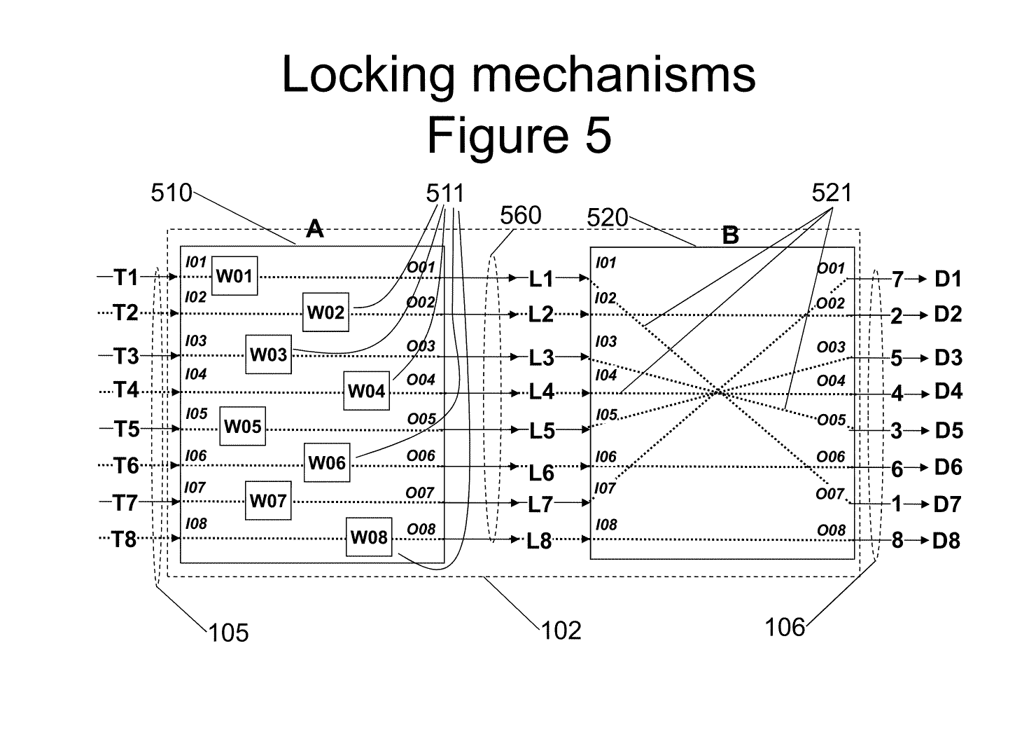

FIG. 5 is the block diagram for electronic locking mechanisms (102). There are two sub-functions in series. The first is a complex weighting processing (510), and the second an I/O switching processing (520). The complex weighting processing (410) features 8 inputs (105), Tm(t), and 8 outputs (560), Lm(t), where m=1 to 8. The weighting on the 8 paths are via 8 multiplications by 8 complex weights (511) individually. Equivalently a weighting is an amplitude modulation and a phase rotation on signals passing through. There are no “cross talks” among the 8 signals (105) during the weighting processing.

The I/O switching process also features 8 inputs (560), Lm(t), and 8 outputs (106), Dm(t), where m=1 to 8. The switching paths (521) can be achieved via LUT.

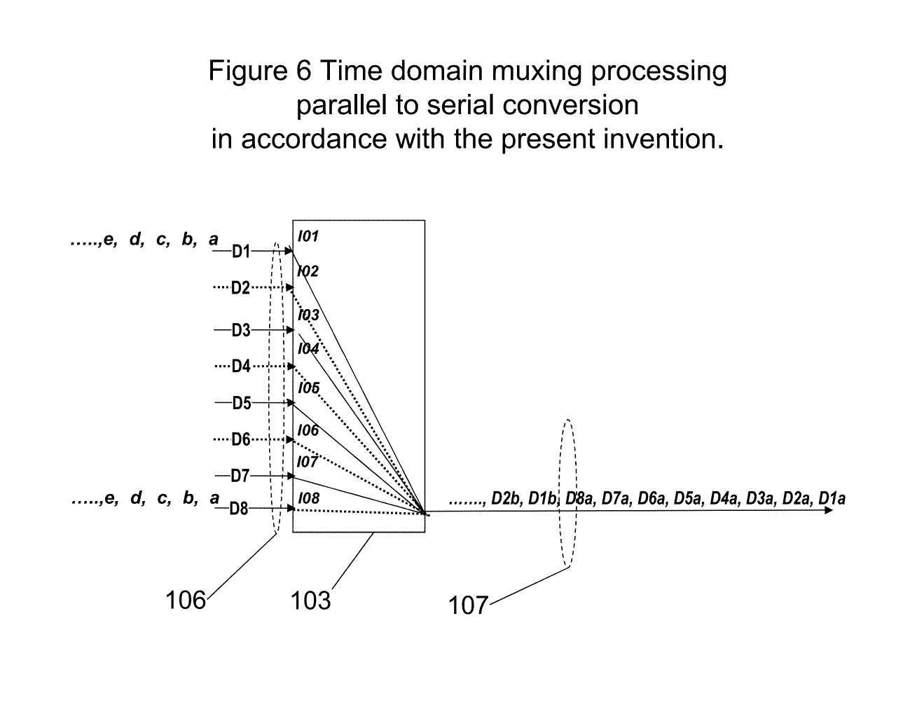

FIG. 6 is a block diagram for time domain muxing processing (103), which features 8 inputs (106) and 1 output (107). The 8 inputs (106) are the Dm(t), for m=1 to 8.

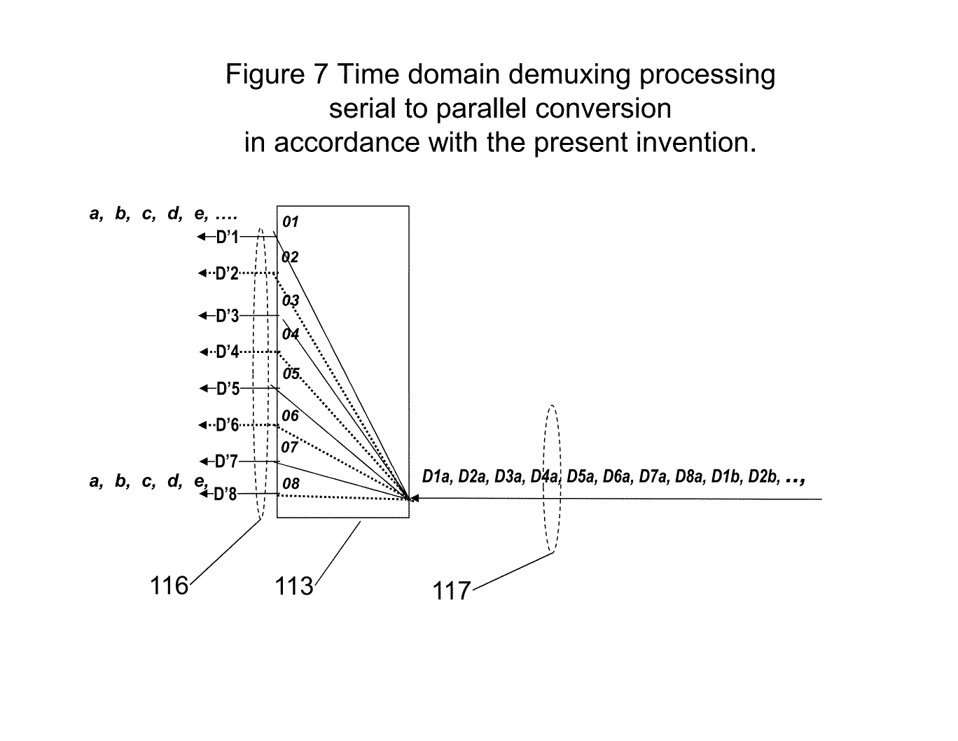

FIG. 7 is a block diagram for time domain demuxing processing (113), which features 1 input (117), and 8 outputs (116). The 8 outputs (116) are the D′m(t), for m=1 to 8.

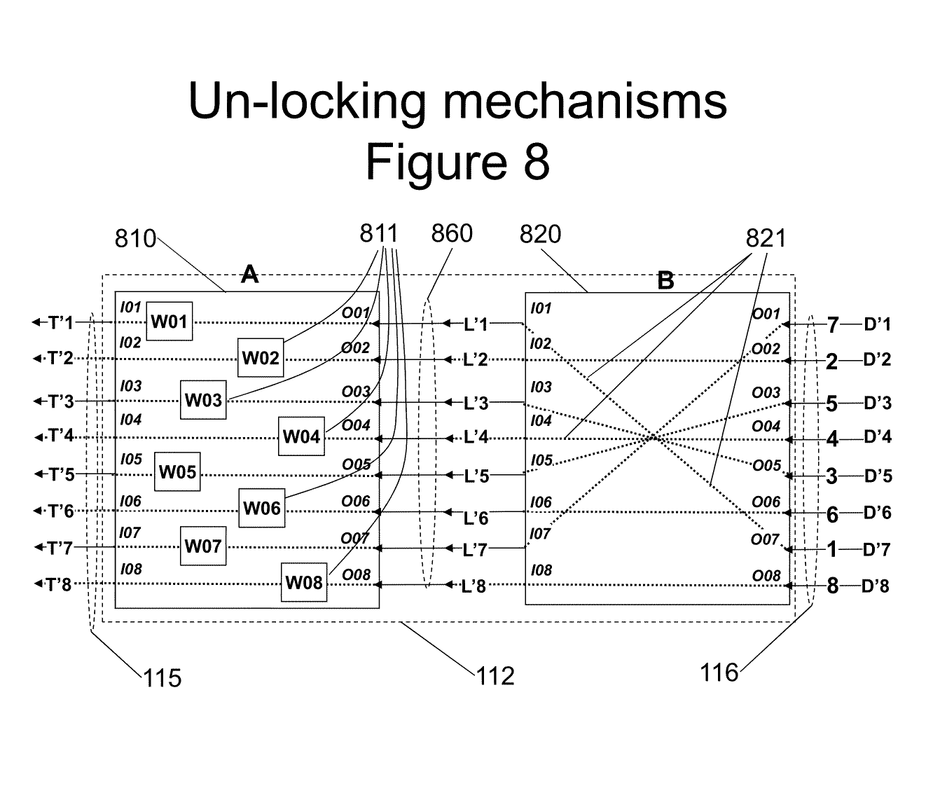

FIG. 8 features electronic un-locking mechanisms (112). There are two sub-functions in series. The first is an I/O switching processing (820), and the second a complex weighting processing (810). The I/O switching process also features 8 inputs (116), D′m(t), and 8 outputs (860), L′m(t), where m=1 to 8. The switching paths (821) can be achieved via LUT. The complex weighting processing (810) features 8 inputs (860), L′m(t), and 8 outputs (115), Tm(t), where m=1 to 8. The weighting on the 8 paths are via 8 multiplications by 8 complex weights (811) individually. Equivalently a weighting is an amplitude modulation and a phase rotation on signals passing through. There are no “cross talks” among signals at different paths.

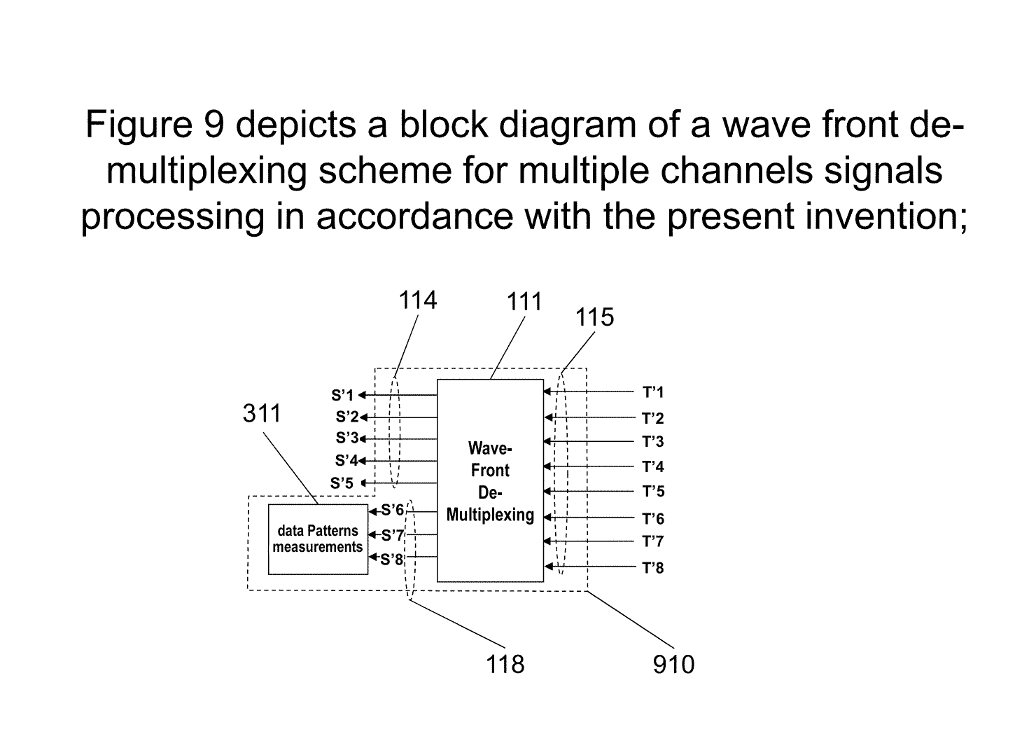

FIG. 9 is WF demuxing processing (111), featuring 8 inputs (115), T′m(t), and 8 outputs (114, 118), S′m(t), where m=1 to 8. All 8 inputs (115), T′m(t), are recovered sub-channel signals. Five outputs (114) are for multiple channel data, and the remaining three outputs (118) are the retrieved data for diagnostics and authentications. These diagnostic and/or authentication signals have been “mixed” with the desired multi-channel data streams embedded in all sub-channel signal streams. They are reconstituted via WF demuxing processing. The recovered signals will be compared with stored references for diagnostic and/or authentication purposes. The reference signals may be the grounding as the ones (111) in FIGS. 1 and 2, and may also be specially designed data patterns, as the one (111) in FIG. 3.

When preprocessing and post-processing are perfectly equalized, the reconstituted signals (118) at the diagnostic and/or authentication ports at identical to the reference data patterns only when with no contaminations or corruptions on transporting or recording the desired multi-channel data. When and if the reconstituted data appear different from the designed references at the diagnostic and/or authentication ports (118), there are two possible causes:
1. pre-processing and corresponding post-processing are not calibrated and equalized, or
2. the recorded data may have been contaminated and shall not be the desired
   The proposed architectures do not require scrutinizing the desired multi-channel data at all, while providing a reliable means to make judgments on the “quality” of recorded and/or transported data.

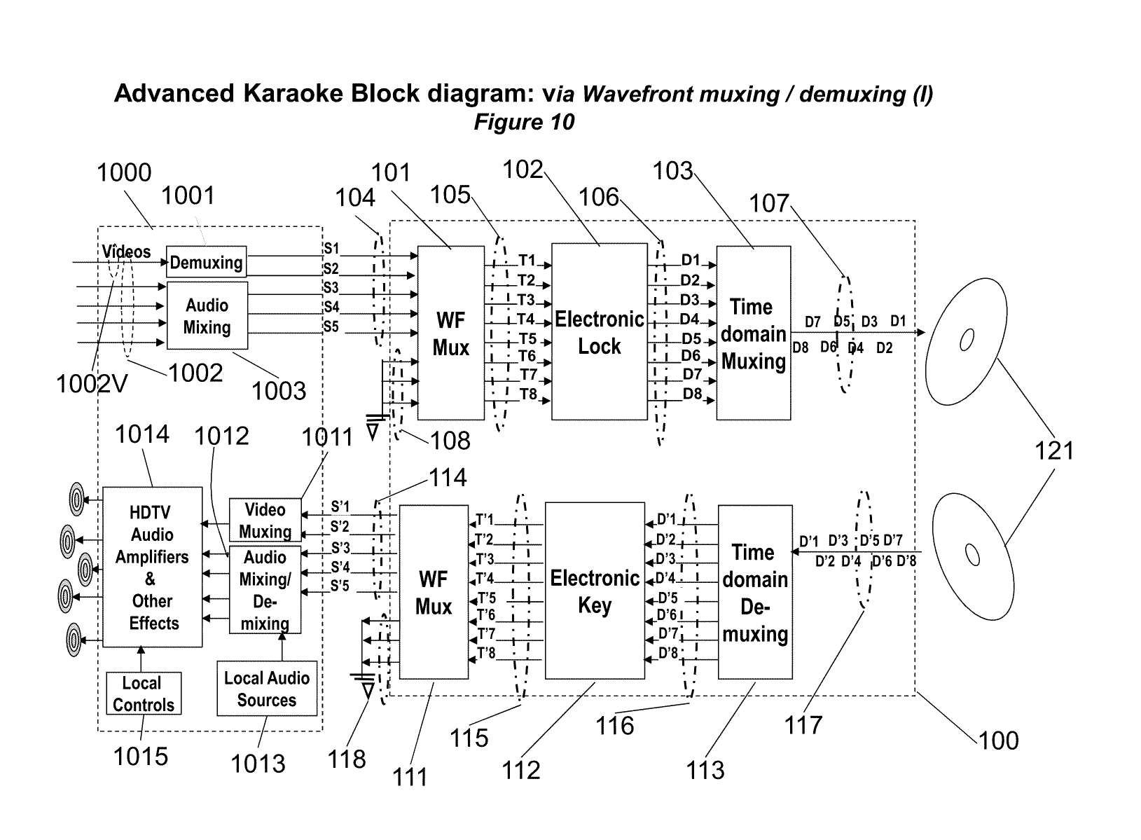

FIG. 10 depicts a block diagram for an advanced Karaoke using WF muxing and demuxing processing. It is generated by modifying FIG. 1. There are concurrent audio and video data streams. The data are pre-processed before recording. As a result, the stored data are in multiple sub-channels logically and each sub-channel records a linear combination of all audio and video data streams. Multiple sub-channels store various linear combinations of the same set of data streams. During the retrieving process, data streams are re-constituted by a post processing which performs linear combinations of recorded data sets on various sub-channels. The pre-processing and post-processing are based on WF muxing and demuxing, which also provide means for diagnostic information on quality of stored data, and authentications on the contents of stored data. Additional processing is added to encrypt and decrypt sub-channel signals.

More specifically, the following are the modifications;
1. The entire blocks, except 2, of FIG. 1 are reproduced in this Figure. They are the controller (130) and the control bus (131). Functionally they shall be here.
2. The additions are all in box 1000, consisting additional Pre-processing and post-processing.
3. Additional pre-processing includes a video de-muxing (1001) processor and an audio mixing (1003) processing.
   a. The video processing is to increase the number of channels (1002V) for video contents
   b. the audio mixing is to reduce the numbers of independent channels (1002)
4. The outputs of pre-processing are connected to the 5 inputs (104) of the MW muxing (101).
5. The inputs to the additional post-processing are from the 5 outputs (114) of the WF demuxing processor (111).
6. There are five additional processing functions;
   a. Video muxing (1011) to recover the recorded video streams,
   b. Audio mixing (1012) to obtain the desired control on recorded vocal tracks independently, and
   c. to add local vocal channels (1013) to the audio tracks properly.
   d. a home theater (1014) with inputs from the video muxing (1011), audio mixing (1012), and
   e. a local control (1015).

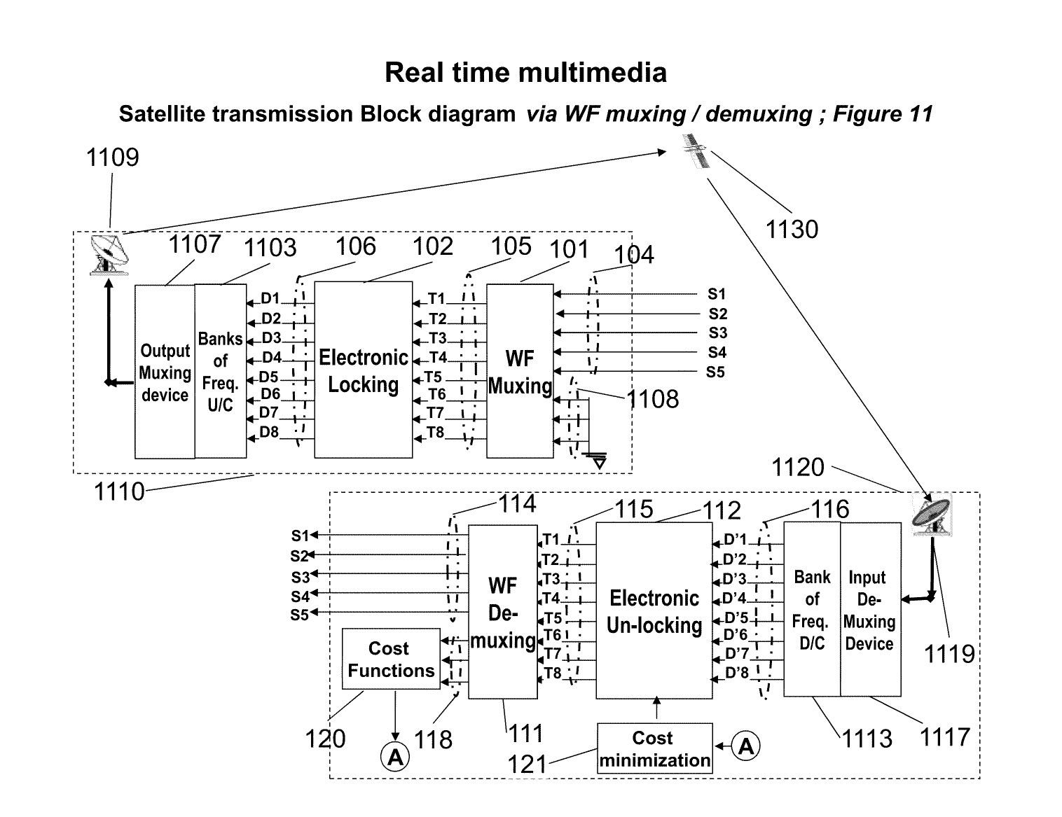

FIG. 11 depicts a functional block diagram of a real time multimedia Satellite transmission/reception via WF muxing/demuxing techniques. There are 5 functional blocks on the transmission chain, and 7 on the receiving chain. The ones on the transmission chain are a WF muxing processing (101), an optional electronic locking mechanism (102), a bank of frequency up-converters (1103), an output multiplexer (1107), and a transmit antenna (1109). The ones on the receiving chain are a receive antenna (1119), an input de-multiplexer (1117), a bank of frequency down converters (1113), an optional electronic un-locking processing (112), WF demuxing processor, a cost generation mechanism (120), and an optimization algorithm (121) based on cost minimization.

It is very similar to FIG. 1. In the transmission chain, the time domain muxing processing (103) in FIG. 1 is replaced by a bank of frequency up-converters (1103) cascaded by an output multiplexer (1107) in FIG. 11. Similarly, in the receiving chain, the time domain demuxing processor (113) in FIG. 1 is replaced by an input de-multiplexer (1117) followed by a bank of frequency down converters (1113).

At an uplink basestation, there are five concurrent wideband data streams, Sm(t) where m=1 to 5. Each features a bandwidth of 36 GHz, same as a standard bandwidth of a Ku transponder. The data are preprocessed before transmission via a WF muxing processor (101). As a result, the pre-processed data are in multiple (8) sub-channels logically, and each sub-channel signal stream consists of a linear combination of all 5 wideband data streams. Multiple sub-channels carry various linear combinations of the same set of data streams. These sub-channel signals (105) are electronically locked by the same locking mechanisms (102) as the one in FIG. 1. They are frequency mapped and frequency up-converted to the frequencies of 8 desired transponders, before transmitted to a designated transponder for data relays.

At a receiving end, data streams are re-constituted by a WF demuxing post processing (111) which performs linear combinations on multiple (8) transponder data sets or 8 sub-channels data streams after receiving from a receive antenna (1119), processed by input de-multiplexer (1117), frequency down-conversions via a bank of down-converters (1113), and an unlocking processing (112). An adaptive processing is incorporated to compensate for phase and amplitude differentials among the 8 transponders due to propagation and/or unsynchronized clock effects using the diagnostic ports (118). Cost functions are indexed and quantified by a cost function generator (120) based on measurements from the diagnostic ports (118). An optimization algorithm (121) based on cost minimization is utilized to alter the amplitudes and phases among the sub-channel signals iteratively. The implementation of additional amplitudes and phases are through “weighting” in the unlocking processor (112).

When the cost functions become zero or below small thresholds, 5 WFs of the five data streams among the 8 sub-channels at the WF demuxer will become orthogonal. The 5 data streams will be reconstituted and appear at the 5 signal outputs (114) of the WF demuxer (111).

1. A novel multi-channel data storage/retrieving system comprising:
a multi-channel data storage processing utilizing wavefront multiplexing and a multi-channel data retrieving processing using wavefront de-multiplexing.

2. The multi-channel data storage system of claim 1, wherein an array of M input data streams configured as an array of concurrent N sub-channel signals through a wavefront multiplexing processing (101) with N-inputs and N-outputs, where M is greater than 1 and N is no less than M, whereby
the remaining N-M inputs (108) to the wavefront multiplexing processing (101) are for diagnostics and authentications as options,
an array of N sub-channel signals (105) are encrypted simultaneously through an optional electronic locking processing (102) with N concurrent outputs (106), consisting of N encrypted signals streams,
an array of N encrypted signals streams (106) are converted into a single stream (107) through an optional parallel to serial conversion processing (103),
a single stream of data (107) to be recorded electronically on portable storage devices (121), and
multi-channel concurrent data (106) will be recorded on portable storage devices (121) directly when there is no optional parallel to serial conversion processing.

3. A multi-channel data retrieving system of claim 1, wherein a single data stream (117) or multiple concurrent data streams (116) retrieved electronically from storage devices (121) comprising:
an array of encrypted N concurrent signals streams (116) are converted from a single data stream (117) through an optional serial to parallel conversion processing (113);
an array of N sub-channel signals (115) are decrypted simultaneously through an optional electronic un-locking processing (112) with N concurrent outputs of decrypted signals streams, or N sub-channel signals (115);
an array of N sub-channel data streams (115), configured as an array of multiplexing concurrently retrieved M data streams (114) through a wavefront de-process (111), where M>1 and N is no less than M.

4. A novel multi-channel data real time transport system comprising:
a multi-channel data transmission processing utilizing wavefront multiplexing and a multi-channel data receiving processing using wavefront de-multiplexing.

5. A multi-channel data transmission processing of claim 4, wherein an array of M input data streams configured as an array of concurrent N sub-channel signals through a wavefront multiplexing processing with N-inputs and N-outputs, where M is greater than 1 and N is no less than M, whereby
the remaining N-M inputs to the wavefront multiplexing processing are for real time diagnostics and authentications as options,
an array of N sub-channel signals are encrypted simultaneously through an electronic locking processing with N concurrent outputs, consisting of N encrypted signals streams,
an array of N encrypted signals streams are converted into a single stream through a parallel to serial conversion processing,
a single stream of data to be transmit electronically to remote sites via wired or wireless means.

6. A multi-channel data receiving system of claim 4, wherein a single stream of data retrieved electronically in real time via wired or wireless means, whereby
an array of encrypted N concurrent signals streams are converted from a single stream through a serial to parallel conversion processing,
an array of N sub-channel signals are decrypted simultaneously through an electronic un-locking processing with N concurrent outputs of decrypted signals streams, or N sub-channel signals.

7. The wavefront multiplexing process of claim 5, wherein the remaining N-M inputs are grounded periodically for real time diagnostic, calibration and equalization of wired or wireless transport means.

8. The wavefront multiplexing process of claim 5, wherein the remaining N-M inputs are injected by unique dynamic data flow patterns periodically for data authentication.

9. The wavefront de-multiplexing process of claim 6, wherein the remaining N-M outputs are utilized in an optimization process periodically for real time diagnostic, calibration and equalization of wired or wireless transport means, whereby
the N-M output signals as measured as the index for cost functions, and summing of all cost functions are total cost equalizations:
equalization via an optimization processing which is based on total cost minimizations for updating the weighting on sub-channels in the un-locking processing,
equalization and calibrations are achieved when total cost is below a pre-determined threshold.

10. The wavefront de-multiplexing process of claim 6, wherein the remaining N-M outputs are utilized in an authentication process under the conditions that the sub-channels are fully equalized,
the N-M output signals will be compared with pre-stored dynamic data patterns periodically,
when the quantified difference below a threshold, the received data will be considered and used as authenticated data,
otherwise, they are not authenticated data.

11. A novel Karaoke data storage/retrieving system comprising:
a Karaoke data storage processing utilizing wavefront multiplexing and a Karaoke data retrieving processing using wavefront de-multiplexing.

12. The Karaoke data storage system of claim 11, wherein an array of M input data streams consisting of M1 audio tracks and M2 video data streams, where M1+M2=M, whereby
there are M1 separable audio tracks, which are generated from combinations of accompanied high fidelity stereo music and artist vocal streams in various languages and/or dialects,
different subsets of M1 audio tracks will serve various applications in playing Karaoke; in learning modes, practice modes, and/or playing modes, and
a high quality video stream input for back ground videos is divided into M2 video data streams; so that the required sub-channel bandwidth is reduced by a factor of M2.

13. The Karaoke data storage system of claim 11, wherein an array of M input data streams configured as an array of concurrent N sub-channel signals through a wavefront multiplexing processing with N-inputs and N-outputs, where M>1 and N is no less than M, whereby
the remaining N-M inputs to the wavefront multiplexing processing are for diagnostics and authentications as options,
an array of N sub-channel signals are encrypted simultaneously through an electronic locking processing with N concurrent outputs, consisting of N encrypted signals streams,
an array of N encrypted signals streams are converted into a single stream through a parallel to serial conversion processing, and
a single stream of data to be recorded electronically on storage devices.

14. A Karaoke data retrieving system of claim 11, wherein a single stream of data retrieved electronically from storage devices, whereby
an array of encrypted N concurrent signals streams are converted from a single stream through a serial to parallel conversion processing,
an array of N sub-channel signals are decrypted simultaneously through an electronic un-locking processing with N concurrent outputs of decrypted signals streams, or N sub-channel signals,
an array of N sub-channel data streams, configured as an array of concurrently retrieved M data streams through a wavefront de-multiplexing process, where M>1 and N is no less than M.

15. The Karaoke data retrieving system of claim 11, wherein an array of M output data streams consisting of M1 audio tracks and M2 video data streams, where M1+M2=M, whereby
there are M1 separable audio tracks, which are generated from combinations of accompanied high fidelity stereo music and artist vocal streams in various languages and/or dialects,
different subsets of M1 audio tracks will serve various applications in playing karaoke such as learning modes, practice modes, and/or playing modes,
a high quality video stream input for back ground videos is divided into M2 video data streams; so that the required sub-channel bandwidth is reduced by a factor of M2.
